(19) United States
(12) Patent Application Publication
(10) Pub. No.: US 2014/0362661 A1
(43) Pub. Date: Dec. 11, 2014

(54) UNMANNED VEHICLE-BASED SEISMIC SURVEYING

(71) Applicant: WESTERNGECO L.L.C., HOUSTON, TX (US)

(72) Inventors: EVERHARD JOHAN MUIJZERT, GIRTON (GB); OLAV LIEN, HORDVIK (NO); KENNETH E. WELKER, OSLO (NO); SUDHIR PAI, HOUSTON, TX (US); HENRY MENKITI, HOUSTON, TX (US); NICOLAE MOLDOVEANU, HOUSTON, TX (US); IAIN COOPER, SUGAR LAND, TX (US)

(73) Assignee: WESTERNGECO L.L.C., HOUSTON, TX (US)

(21) Appl. No.: 14/251,338

(22) Filed: Apr. 11, 2014

Related U.S. Application Data
(60) Provisional application No. 61/816,103, filed on Apr. 25, 2013.
(60) Provisional application No. 61/815,006, filed on Apr. 23, 2013.

(51) Int. Cl. G01V 1/38

(52) U.S. Cl. CPC G01V 1/3817; G01V 1/3808
USPC 367/15

(57) ABSTRACT

A technique includes a technique includes providing a plurality of acquisition components for performing a survey of a geologic region of interest, where the plurality of acquisition components comprising receivers and at least one source. The technique includes using at least one marine unmanned vehicle to position at least one of the receivers in the survey; and deploying at least at one of the acquisition components in a well or on land.

### CROSS-REFERENCE TO RELATED APPLICATION

This application claims the benefit of U.S. Provisional Patent Application Ser. No. 61/815,006 filed Apr. 23, 2013, which is incorporated herein by reference in its entirety.

### BACKGROUND

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensor, both hydrophones and geophones, and/or other suitable sensor types. A typical measurement acquired by a sensor contains desired signal content (a measured pressure or particle motion, for example) and an unwanted content (or “noise”).

### SUMMARY

The summary is provided to introduce a selection of concepts that are further described below in the detailed description. This summary is not intended to identify key or essential features of the claimed subject matter, nor is it intended to be used as an aid in limiting the scope of the claimed subject matter.

In an example implementation, a technique includes providing a plurality of acquisition components for performing a survey of a geologic region of interest, where the plurality of acquisition components comprising receivers and at least one source. The technique includes using at least one marine unmanned vehicle to position at least one of the receivers in the survey; and deploying at least at one of the acquisition components in a well or on land.

In another example implementation, a system includes at least one source disposed on land; at least one sensor; and at least one marine unmanned vehicle that is connected to the geophysical sensor(s) to acquire data representing energy attributable at least in part to the activation of the source(s).

In another example implementation, a technique includes acquiring first data by at least one geophysical receiver inside a well. The first data represents energy that is attributable at least in part to at least one source. The technique includes acquiring second data by at least one marine unmanned vehicle-based receiver that is outside of the well. The second data represents energy that is attributable at least in part to the activation of the source(s).

In another example implementation, a system includes at least one seismic source; and at least one receiver that is disposed in a well. The receiver(s) are adapted to acquire first data representing energy attributable at least in part to the activation(s) of the source(s). The system includes at least one unmanned marine vehicle-based receiver outside of the well to acquire second data representing energy attributable at least in part to the activation of the source(s).

In yet another example implementation, a technique includes activating at least one seismic source, which is disposed in a well. The technique includes acquiring data outside of the well by at least one unmanned marine vehicle-based receiver, where the data acquired by the unmanned marine vehicle-based receiver(s) are attributable at least in part to the activation of the source(s).

Advantages and other features will become apparent from the following drawings, description and claims.

### BRIEF DESCRIPTION OF THE DRAWINGS

FIGS. 1, 4 and 5 illustrate transition zone acquisition systems that use marine unmanned vehicles (UVs) according to example implementations.

FIG. 2 is a flow diagram depicting a technique to use marine UV-based seismic receivers in a seismic survey of a geologic structure according to an example implementation.

FIG. 3 is a flow diagram depicting a technique to use marine UV-based seismic receivers in a seismic survey of a geologic structure located in a transition zone according to an example implementation.

FIG. 6 is a schematic diagram of an acquisition system to perform a zero offset vertical seismic profile (VSP) survey using marine UVs according to an example implementation.

FIG. 7A is an illustration of source and receiver positions in a two-dimensional (2-D) zero offset VSP survey that uses marine UVs according to an example implementation.

FIG. 7B is an illustration of source and receiver positions in a three-dimensional (3-D) zero offset VSP survey using marine UVs according to an example implementation.

FIG. 8 is a flow diagram depicting a technique to perform a seismic survey of a geologic structure using an acquisition system that includes components deployed in a well and components deployed on marine UVs according to an example implementation.

FIG. 9 is a flow diagram depicting a technique to use marine UVs in an offset VSP survey according to an example implementation.

FIG. 10 is a schematic diagram of an acquisition system to perform a walkaway VSP survey using marine UVs according to an example implementation.

FIG. 11A is an illustration of source and receiver positions in a 2-D walkaway VSP survey that uses marine UVs according to an example implementation.

FIGS. 11B, 13A and 13B are illustrations of source and receiver positions in 3-D walkaway VSP surveys that use marine UVs according to example implementations.

FIG. 12 is a flow diagram depicting a technique to use marine UVs in a walkaway VSP survey according to an example implementation.

FIGS. 14 and 15 are flow diagrams depicting techniques to coordinate seismic receiver and source movements in a walkaway VSP survey that uses marine UVs according to example implementations.

### DETAILED DESCRIPTION

Systems and techniques are disclosed herein for purposes of using unmanned vehicles (UVs) in the seismic survey of a geologic structure. More specifically, the UVs are used to carry one or multiple seismic receivers or sources in water, or any other seismic related technology, which may be freshwater, salt water or brackish water, depending on the particular implementation. As such, the UVs are referred to as “marine UVs” herein. In general, as described below, a given marine UV contains a steering system and may be used to transport/tow receiver(s)/source(s) in a shallow or deep water region for purposes of conducting a seismic survey of a geologic structure where conventional towed marine streamer surveys are unsafe due to the shallow water depth. As examples, the UV's steering system may be constructed to following a preprogrammed path or course; the steering system may be remotely controlled by a human operator; the steering system may follow one or more predetermined actions based on sensed conditions or remote operator input; and so forth.

In the context of this application, an unmanned vehicle, or “UV,” includes such vehicles as an autonomous underwater vehicle (AUV), which conducts its mission without operator intervention. In this manner, the AUV may be pre-programmed with a survey course and be automated to follow a predetermined course until the survey is complete. A remotely operated vehicle (ROV) is another type of UV, which may be wirelessly controlled by an operator from a remote location or may be controlled via a tethered cable-based link.

As a more specific example, in accordance with some implementations, the UV may be a waveglider, such as a waveglider available from Liquid Robotics, Inc. of Sunnyvale, Calif. In general, the waveglider is an Autonomous Marine Vehicle (AMV) that has a surface float that is tethered to a sub-marine unit, or glider, beneath the surface. The glider contains controlled vanes to steer the waveglider. The waveglider may be an AUV in accordance with example implementations. In accordance with some implementations, the waveglider may have an umbilical of seven meters (m) between the surface float and the swimmer and therefore, may require the same corresponding water depth, which for this example is a depth of at least seven meters. Depending on the water depth in a given transition zone, the waveglider may be equipped with a shorter umbilical for purposes of navigating more shallow water. As another example, in accordance with further implementations, the UV may be a Slocum Glider, which is available from Teledyne Webb Research of Falmouth, Mass.; or the uRaptor underwater glider that is available from Go Science Ltd. of Bristol, United Kingdom. Other UVs may be used, in accordance with further example implementations.

Depending on the particular implementation, the UV may be electrically powered, fuel or gas powered, or may be powered by a combination of gas and electric motors/engines. As another example, the UV may be partially or entirely powered by a hydrogen fuel cell-based engine. In further example implementations, the UV may be powered by waves, wind energy, solar energy or buoyancy. Moreover, in accordance with some implementations, the UV may operate from a stored energy source; may derive its power partially or entirely from wave motion; may derive its power partially or entirely from solar energy; may derive its power from a combination of those power sources; and so forth. In accordance with example implementations, the UV may operate on the water surface. However, in accordance with further implementations, the UV may operate below the water surface. Moreover, in accordance with further example implementations, the UV may operate on the sea bed.

In general, the UV contains one or more fins or vanes to control its direction and speed; an actuator-controlled rudder to control its direction; and a controller to control the actuator(s) and communicate with centralized control system and possibly other UVs for purposes of controlling the UV. The UV may also have a navigation system for purposes of precisely controlling the path of the UV. In general, the controller may be processor-based system. For example, the controller may be a physical machine that is formed from actual hardware and software, such as a machine that includes one or more processors (central processing units (CPUs), microcontrollers, field programmable gate arrays (FPGAs), and so forth) as well as a communication interface (a wireless transceiver interface to communicating control signals and data, for example) and non-transitory storage (a semiconductor device-based memory, for example) to store programs instructions, datasets, data representing navigation waypoints, and so forth.

The UV also contains a positioning system, such as GPS or USBL (Ultra Short BaseLine) whos output is available to the controller. For example, the UV may include a conventional GPS system for surface units and/or short base line acoustic positioning systems for positioning a streamer being towed relative to the UV. Other positioning systems may utilize one or more compasses with or without accelerometers to determine streamer shape and location relative to the UV. Multiple UVs may employ relative positioning methods, such as RTK or acoustic distance measuring systems. Radar positioning methods might also be used, with a master vessel or platform using micro-radar systems for locating one or more gliders relative to its known positing.

The UVs may also be used with conventional towed arrays to aid in positioning of the streamers. In such implementations, the UVs may provide one or more Global Navigation Satellite Systems (GNSS) Earth Centered Earth Fixed (ECEF) reference points. For example, the UVs may be equipped with GPS devices. The deployed streamers may be equipped with acoustic positioning systems, such as the IRMA system that is described in U.S. Pat. No. 5,668,775, which is hereby incorporated by reference. Sensors in or on the streamers may be positioned with respect to a short baseline (SBL) or ultra short baseline (USBL) transducer head that is mounted on the wave glider platform with reference to the GNSS antenna. To further improve the position accuracy of the streamers, the UVs in the survey area may become part of the acoustic positioning system. In this regard, the UVs may record the acoustic signals emitted by the acoustic sources in the streamers and transmit those recordings to a surface vessel and/or to other UV(s). The UVs may also carry additional acoustic sources whose signals are recorded by the streamers. The recorded acoustic signals from the streamers and from the UVs may then be combined and used to determine an even more accurate position of the streamers and the UVs. In general, the UV may use any of the positioning systems that are described in U.S. Patent Application Publication No. US 2012/0069702, entitled, “MARINE SEISMIC SURVEY SYSTEMS AND METHODS USING AUTONOMOUSLY OR REMOTELY OPERATED VEHICLES,” which published on Mar. 22, 2012 and is hereby incorporated by reference in its entirety.

The shallow water region may be part of a transition zone in which the shallow water region is adjacent to a dry, land region and possibly a deeper water region. In this manner, a “transition zone” refers to a region that includes one of multiple dry regions and one or multiple wet regions; and in general, a “transition zone” refers to any type of environment that includes wet and dry regions, such as the sea, lakes, rivers, swamps, marsh land, and so forth.

As another example, the shallow water region may be near a well (a subsea well, for example); and a given UV may be used to tow/transport receiver(s)/source(s) in a seismic profile (VSP) survey, which relies on the receiver(s)/source(s) towed by marine UV(s) as well as source(s)/receiver(s) that are deployed in the well.

A seismic survey may be carried out in a marine environment in a variety of ways. For example, a towed array survey may involve the use of an acquisition system that includes one or more large surface vessels, which tow multiple seismic streamers and sources. The streamers may be over ten kilometers (km) long and may contain a relatively large number of closely-spaced hydrophones, as wells as particle motion sensors, such as accelerometers. In the context of this application, the hydrophones and particle motion sensors are generally referred to as “receivers.”

Another type of marine acquisition system includes nodes that are deployed on the sea floor as part of a cable or as individual pods. The nodes may also contain seismic receivers, such as a pressure sensor, a vertical geophone and two orthogonal horizontal geophones, as well as a data recorder and a battery pack. Other seismic receivers, such as accelerometers or other particle motion sensors may also be employed. As examples, the nodes may be deployed using a remotely operated vehicle (ROV) or may be deployed from a surface vessel.

The sources may be deployed in various ways. An airgun may be deployed from a far ranging source vessel, and the airgun may also be deployed as a portable system on a small vessel that carries a compressor and air guns or clusters, which are deployed from the side to create a source signature.

It may be particularly challenging to conduct a conventional marine seismic survey, whether using sea floor-deployed nodes or towed seismic streamers, in a transition zone. In this manner, as parts of the survey area are dry land and other parts are submerged below water. A mixture of seismic sources deployed singularly or simultaneously may be used. Moreover, land sources, such as vibrators, or dynamite impulse-type sources as well as marine sources, such as marine vibrators or airguns may be used. A mixture of seismic receivers may be used, such as hydrophones, geophones and accelerometers, as a few examples.

A particular challenge for a survey in a transition zone is that it is relatively difficult to record the data in the shallow water near the shore, as it is relatively challenging to place land geophones in the transition zone. Moreover, it may be particularly challenging for a larger streamer vessel that has a relatively large draft to enter a shallow water region, whose minimum depth is too shallow to accommodate the vessel's draft. Although a small vessel with a relatively smaller draft and a corresponding relatively smaller number of receivers may be deployed in the transition zone, in practice, it may be beneficial to have many sensors covering a large area; and therefore, using many small vessels may make it challenging to efficiently conduct the seismic survey. In accordance with the systems and techniques that are disclosed herein, UVs are used to transport seismic receivers in such shallow water regions.

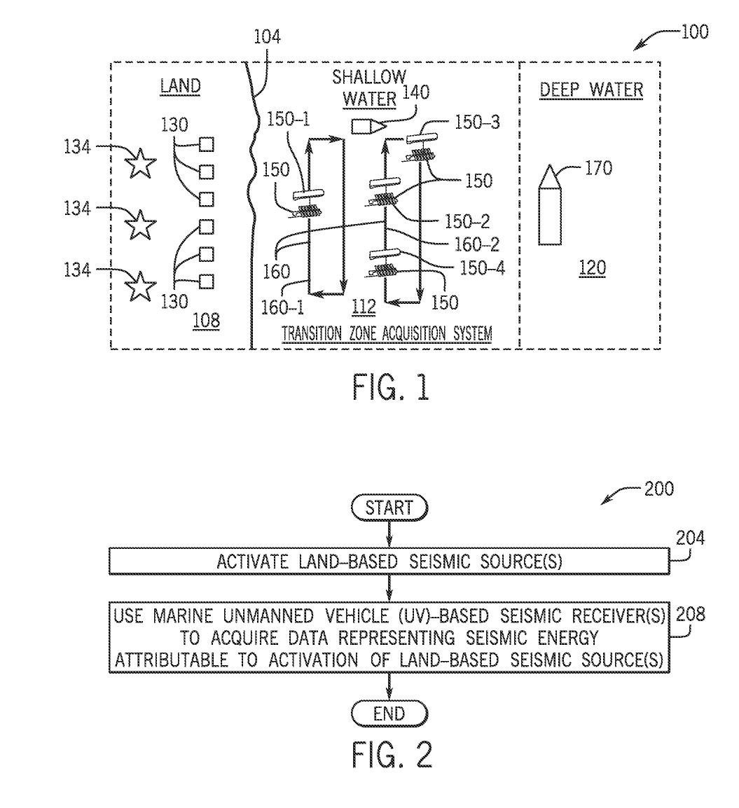

As a more specific example, FIG. 1 depicts a transition zone acquisition system 100 for surveying a transition zone that includes a land region 108, a shallow water region 112 and a deep water region 120. As an example, the shallow water region 112 may be associated with a minimum water depth of one meter and the deep water region 120 may be associated with a minimum water depth of twenty meters. The land region 108 generally refers to an area of dry land, which is not covered by water and is separated from the water at shoreline 104.

For the example transition zone acquisition system 100, seismic receivers 130 are deployed in the land region 108, along with land-based seismic sources 134. For purposes of positioning seismic receivers in the shallow water region 112, the transition zone survey system 100 uses UVs 150 (UVs 150-1, 150-2, 150-3 and 150-4, being depicted in FIG. 1 as examples), which, in accordance with example implementations, are pre-programmed to sail in predetermined paths. For the example of FIG. 1, the UVs 150 sail in two circular paths 160-1 and 160-2: the UV 150-1 sails along the path 160-1; and the UVs 150-1, 150-2 and 150-3 sail along the path 160-2. In accordance with some implementations, the UV 150 may contain a global positioning satellite (GPS)-based navigation system, or other navigational aid, for purposes of steering the UV 150 along its path 160 and the navigational waypoints for the associated paths may be programmed into the UVs 150.

In one application, a given UV 150 may be used for station keeping instead of sailing along a predetermined path. Here, the UV's navigation system is programmed to keep the UV at a fixed position. In further implementations, a given UV 150 may have an anchor to keep the UV at a fixed position. This anchor may be released on command and allow the UV to move to a new position or return to its operational base. Alternatively, the anchor can be hooked and secure itself to the sea bottom with the motion of the prevailing current. The anchor can then be released by using the propulsion system of the vehicle to move in the opposite direction to the current. The hook can be controlled by an automatic retraction mechanism to allow it to retract and engage with the bottom as desired. The anchor may be located at the end of the recording cable to give the cable a vertical component of orientation or at the end of a separate retractable cable or rope. Thus, many implementations are contemplated, which are within the scope of the appended claims.

As also depicted in FIG. 1, the transition zone acquisition system 100 may employ the use of larger surface vessels. For example, a relatively deep water surface vessel 170 may be used in the deep water region 120 for purposes of towing a seismic source and/or a streamer vessel. Moreover, although one surface vessel 170 is depicted in FIG. 1 for the deep water region 120, in accordance with further example implementations, multiple surface vessels 170 may be employed towing seismic streamers and/or sources. As also shown in FIG. 1, a smaller draft surface vessel 140 may be used in the shallow water region 112 for purposes of towing a seismic source.

Thus, referring to FIG. 2, in accordance with example implementations, a technique 200 includes activating (block 204) one or multiple land-based seismic sources and using (block 208) one or multiple marine unmanned vehicle (UV)-based seismic receivers to acquire data representing seismic energy attributable to the activation of the land-based seismic source(s).

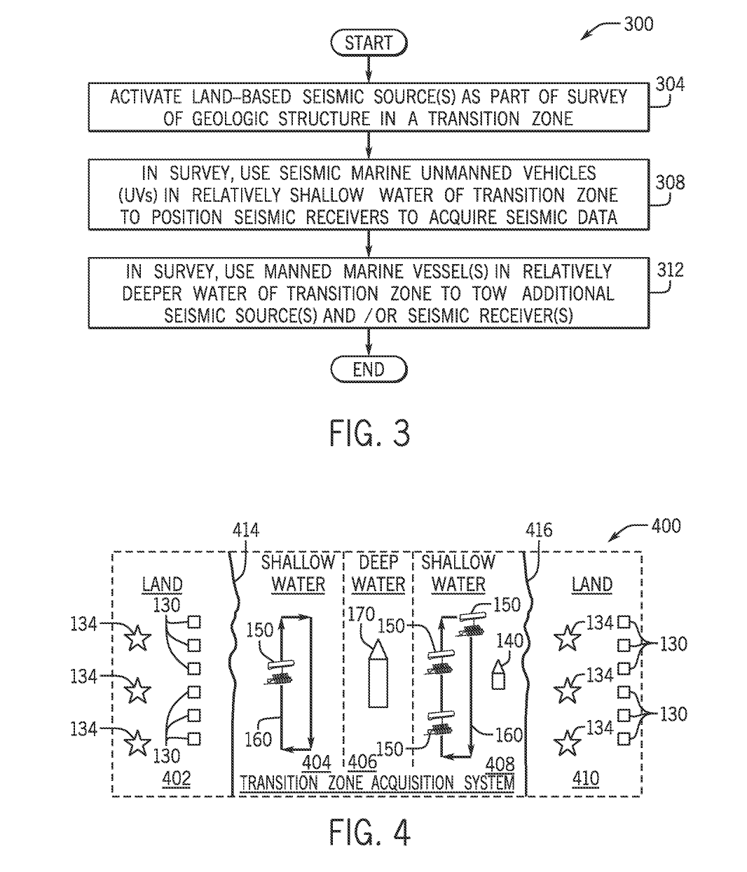

More specifically, referring to FIG. 3, in accordance with example implementations, a technique 300 includes activating (block 304) one or multiple land-based seismic sources as part of a survey of a geologic structure in a transition zone. The technique 300 includes in the survey, using one or multiple marine unmanned vehicles (UVs) in a relatively shallow water of the transition zone to position seismic receivers to acquire seismic data. Moreover, pursuant to the technique 300, in the survey, one or multiple manned marine vessels are used in relatively deeper water of the transition zone to tow one or multiple additional seismic sources and/or seismic receivers, pursuant to block 312.

FIG. 4 illustrates a transition zone acquisition system 400 in accordance with further example implementations. For this example, the transition zone acquisition system 400 is used in a transition zone that includes two land regions 402 and 410; two shallow water regions 404 and 408 (separated from the land regions 402 and 410 by shorelines 414 and 416); and a deep water region 406 that is disposed between the two shallow water regions 404 and 408. For this example implementation, sources 134 and receivers 130 are deployed on the land regions 402 and 410; and UVs 150 are used in the shallow water regions 404 and 408. At least one deep water surface vessel 170 may be used in the deep water region 406 (at least one smaller vessel 140 may be used in at least one of the shallow water regions (such as shallow water region 408 for the example of FIG. 4) for purposes of towing seismic source(s)/seismic receiver(s).

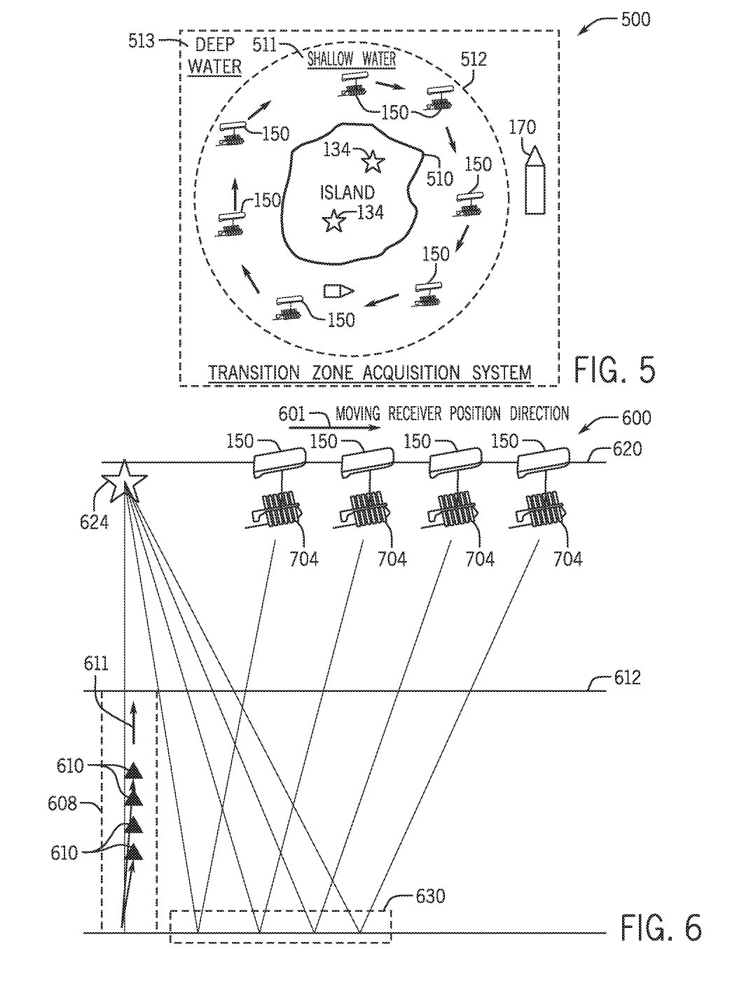

Referring to FIG. 5, as another variation, a transition zone acquisition system 500 may be used for purposes of conducting a seismic survey of a geologic structure that exists near an island 510. For this system 500, sources 134 are deployed on the island 510. UVs 150 of the systems 500 sail in a shallow water region 511 surrounding the island 510 (and demarcated from a deep water region 513 by a dashed boundary line 511 in FIG. 5). Moreover, as also shown in FIG. 5, a deeper water surface vessel 170 may be used in the deep water region 513 for purposes of towing one or more seismic sources or seismic receivers.

In further example implementations, UVs may be used in an acquisition system that performs a Vertical Seismic Profile (VSP) survey, of a geologic structure in a marine environment and which contains one or more seismic sources and/or one or more seismic receivers that are disposed in a well. There are many types of VSP surveys. In a zero offset VSP survey, seismic receiver(s) are disposed in the well, and seismic source(s) may be disposed close to the wellbore and generally above the receivers that are inside the well. For an offset VSP survey, seismic source(s) are disposed outside of the wellbore, receivers are disposed inside the wellbore, and the seismic sources are disposed at offsets from the receivers. For a walkaway VSP survey, seismic source(s) are disposed outside of the wellbore and are moved to a progressively farther offset during the survey.

In general, in accordance with example implementations, the UVs are employed in a VSP acquisition system to acquire seismic data from marine UV-based receivers, such that the acquisition system acquires a combination of seismic data acquired from receivers within the well and seismic data acquired from the floating UV-based receivers. In accordance with example implementations, a marine seismic source is used, along with a downhole array of seismic receivers; and one or more UVs are used to transport one or more seismic receivers. As examples, the seismic receivers may be towed on a streamer that extends from a particular UV; may be located onboard the UV; and so forth.

In accordance with example implementations, the VSP survey involves simultaneously recording date representing energy (attributable to a particular shot of a seismic source, for example) in a downhole receiver array and in the UV-based seismic receivers. The UVs are located such that the data acquired by the associated seismic receivers improves the illumination of the rock layers near the downhole receiver array. Conceptually, this illumination may be characterized by the midpoints between the source and receiver positions. The extra data increases the aperture of the seismic data at the subsurface reflection points near the receiver array. The data acquired by the seismic receivers associated with the UVs aids in separating the seismic multiples from the downhole dataset. As disclosed herein, the UVs may be used in a VSP survey in a number of different configurations.

In general, the seismic source for a VSP survey, in accordance with example implementations, may be located on land, close to water where the UV can operate. Alternatively, the seismic source may be placed in the water column and may include one or more airguns, marine vibrators or other seismic source. In general, the source may be hanging from an offshore installation, a rig, a drillship, or from a dedicated surface vessel. The seismic source, as examples, may be positioned a few meters below the water surface, such as 6-10 m, in accordance with example implementations. In further example implementations, the seismic source may be disposed on the seabed. In yet further example implementations, the seismic source or sources may be disposed in a borehole of the well. Thus, many implementations are contemplated, which are within the scope of the appended claims.

The receivers used in the VSP survey may be located in a borehole of the well and may be accessed from a rig or vessel. The borehole may be vertical, angled, dipping or have a horizontal component, depending on the particular example implementation. As a more specific example, a dedicated tool having multiple seismic receivers (a tool having geophones or accelerometers) or particle motion-sensitive fiber optic cables that measure the Earth's motion may be lowered into the borehole. In general, this tool may be positioned at a targeted depth, and subsequently, shots may be fired by the seismic source(s). As described further herein, in some implementations, the tool may be moved to a different position in the borehole after which shots are fired again, at the same positions or at a new position. In accordance with further example implementations, the receivers may be permanently installed in the well and thus, may not move. For example, the receivers may be formed from a fiber optic cable that is wrapped around a casing or tubular string; or in accordance with further example implementations, the cable may freely hang within a wellbore.

The marine environment presents certain challenges when conducting a VSP survey. When a VSP survey is conducted on land, the seismic receivers may be placed on the land surface. In a marine environment, the seismic sensors may be disposed on the sea bed, as either sea bed nodes or as part of a cable system. Moreover, the receivers may be formed from particle motion sensitive fiber optic cables on the surface (land or marine) in an array, which may be in a geometrical pattern or may be freely-spaced. The VSP-survey may be conducted in relatively shallow waters or in deeper waters, depending on the particular implementation.

Referring to FIG. 6, in accordance with example implementations, an acquisition system 600 may be used to acquire seismic data for a zero offset VSP survey. As depicted in FIG. 6, the system 600 includes downhole-based receivers 610 that are located in a subsea wellbore 610, which extends beneath a sea floor 612. A stationary marine seismic source 624 that is disposed near or directly above the downhole receivers 610. As examples, the stationary seismic source 624 may be disposed near or at a sea surface 620 on a rig, surface vessel, on a platform, and so forth, depending on the particular implementation. The acquisition system 600 further includes multiple UVs 150, which contain corresponding seismic receivers. In this manner, each UV may contain one or multiple receivers 704, which may be disposed on a streamer towed by the UV 150, on the UV's platform, and so forth. In general, the UVs 150 may sail along a line 601 in a two-dimensional (2-D) survey (as depicted in FIG. 6) or along respective azimuthal lines in a three-dimensional (3-D) survey, depending on the particular implementation, as further described herein. In this context, a 2-D survey refers to a survey where temporal data is acquired in one spatial dimension; and a 3-D survey refers to a survey where temporal data is acquired in two spatial dimensions, such as in a (near) horizontal plane, as an example. As shown in FIG. 6, the UVs 150 sail away from the well 608 during the course of the survey.

In general, shots from the stationary seismic source 624 are repeated at the same location, and the downhole receivers 610 are moved upwardly in the wellbore 608 (as indicated by direction 611) between shots. In general, the UVs 150 are positioned away from the downhole receivers 610 and acquire data from sub-surface illumination points 630 near the receivers 610. The UVs 150 that are disposed farther away from the receivers 610 acquire data that corresponds to midpoints farther away from the receivers 610.

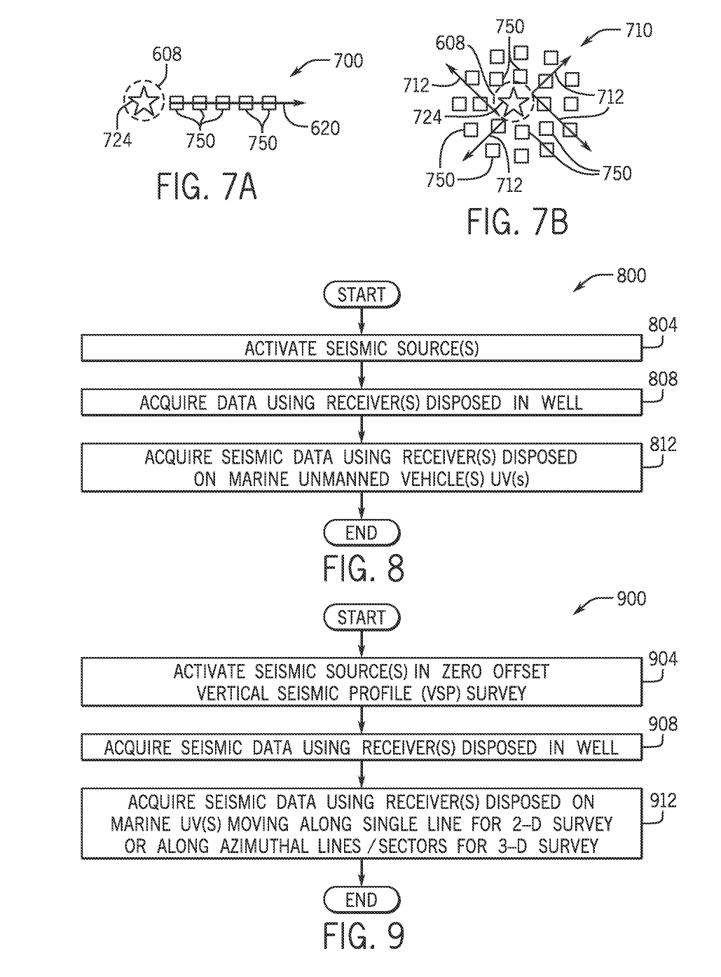

Referring to FIG. 7A in conjunction with FIG. 6, for a 2-D VSP survey (as depicted in FIG. 6), seismic receivers 704 disposed on the UVs 150 move along a line away from the stationary seismic source 624, as depicted by a stationary source position 724 in FIG. 7A (corresponding to source 624) and receiver positions 750 (correspond to receiver 704) that move along the direction 620.

Referring to FIG. 7B in conjunction with FIG. 6, for a 3-D VSP survey, the seismic receivers 704 are disposed on the UVs 150 move away from the stationary seismic source 624 along azimuthal lines (such as example azimuthal lines 712) between shots as indicated by source 724 and receiver 750 positions.

In general, the number of UVs 150 (and the number of receivers 704) depends on the desired coverage and is related to the number of shots fired, which may be between tens to thousands of shots. The resulting dataset may be called a “reversed walkaway VSP survey” where the seismic source is stationary and the UV-based receivers move during the survey.

Referring to FIG. 8, thus, in accordance with example implementations, a technique 800 to perform a VSP seismic survey, in general, includes activating one or multiple seismic sources, pursuant to block 804 and acquiring (block 808) seismic data using one or multiple receivers that are disposed in a well. The technique 800 includes further acquiring seismic data using one or multiple receivers that are disposed on marine UVs.

For the above-described offset VSP survey (or “reversed walkaway VSP survey”), a technique 900 of FIG. 9 includes activating (block 904) one or multiple seismic sources and acquiring (block 908) seismic data using one or multiple receivers that are disposed in a well. The technique 900 further includes acquiring seismic data using one or multiple receivers that are disposed on marine UVs that move along a single line for a 2-D survey or along azimuthal lines for a 3-D survey, pursuant to block 912.

Seismic acquisition systems may use UVs to conduct other types of VSP seismic surveys, in accordance with further example implementations. For example, if a vertical incident survey is conducted, the UVs may be placed horizontally in between the source and receiver locations. As the receivers are moved up the borehole, the seismic source and UVs are also moved. The seismic receivers on the UVs acquire data that provide extra seismic illumination.

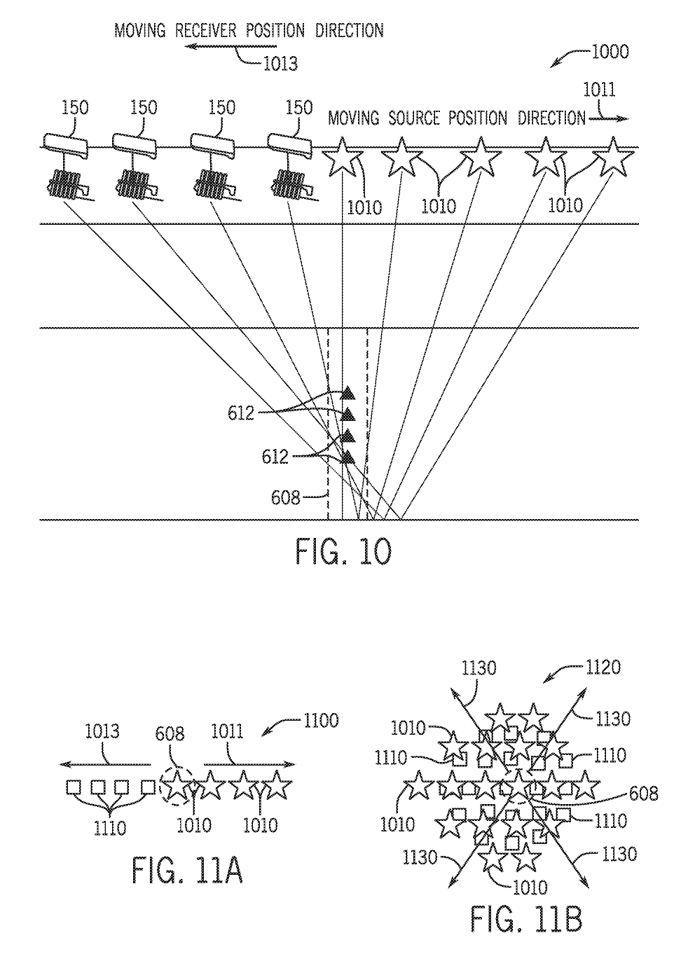

As another example, FIG. 10 depicts an acquisition system 1000 that may be used to conduct a walkaway VSP survey. For this survey, the UVs 150 are disposed on one side of the downhole receivers 610, and a moving seismic source is positioned to move away from the receivers 610 in the opposite direction for a 2-D survey. In this regard, FIG. 10 depicts moving source positions 1010 along a direction 1011 and the receivers 150 moving along an opposite direction 1013 during the survey. This is also illustrated in a top view of the 2-D survey in FIG. 11A, which shows the source positions 1010 and receiver positions 1110. This arrangement ensures that the midpoints are near the location of the downhole receivers 610.

For a 3-D or 4-D VSP survey, the UVs 150 and seismic sources may span around the receivers 610 (and wellbore 608) and move outwardly from the wellbore 608. For example, referring to FIG. 11B in conjunction with FIG. 10, for a 3-D survey, the seismic source positions 1010 may generally encircle the downhole receivers 610 in the wellbore 608; and the UVs 150 may be disposed in a circular pattern, either stationary or moving, depending on the particular implementation. If the UVs 150 move at different speeds, (slower or near stationary, as compared to the seismic sources, for example), the UVs may be unable to keep up the spiral pattern. Therefore, in accordance with further example implementations, the source positions and receivers 1110 on the UVs may be positioned as depicted in FIG. 13A.

Referring to FIG. 13A in conjunction with FIG. 10, the survey may cover an area that is defined by a certain radius from the wellbore or the surface projection of the receivers placed in the well (represented by a dashed circle 1304 in FIG. 13A). The 3-D survey progresses by disposing the sources and UV-based receivers along particular azimuthal lines 1130, one at a time. After all of the data is acquired along the given azimuthal line, the survey progresses to the next azimuthal line. For example, the survey may first provide by moving the source and receivers along opposing azimuthal lines 1130-1 and 1130-2; and then the survey may continue by resetting the source and receiver positions and moving the source and receivers along azimuthal lines 1130-3 and 1130-4.

Referring to FIG. 13B in conjunction with FIG. 10, in further example implementations, both the sources and the UV-based receivers are located in opposing azimuthal sectors 1354. After all of the data is acquired in the opposing azimuthal sectors, the sources and UVs move to the next azimuthal sector. Thus, many implementations are contemplated, which are within the scope of the appended claims.

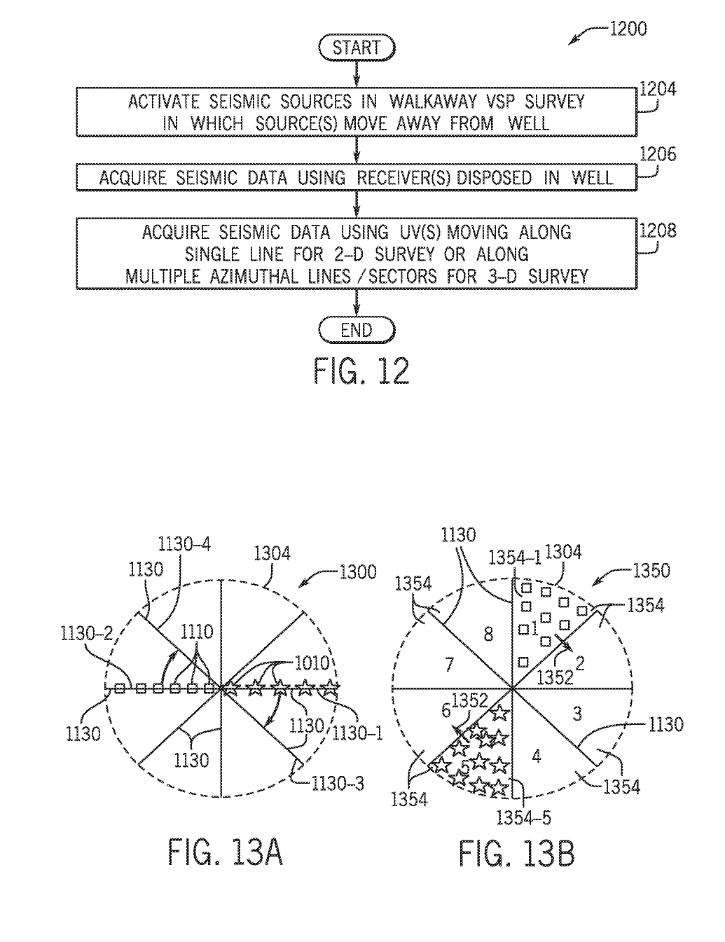

Thus, to summarize, a technique 1200 that is depicted in FIG. 12 may be used for purposes of performing a walkaway VSP survey. Pursuant to the technique 1200, one or multiple seismic sources are activated in a walkaway VSP survey, pursuant to block 1204. Seismic data may then be acquired using one or more receivers that are disposed in a well, pursuant to block 1206; and seismic data may also be acquired using one or multiple UVs that move along a single line for a 2-D survey or along multiple azimuthal lines or sectors for a 3-D survey.

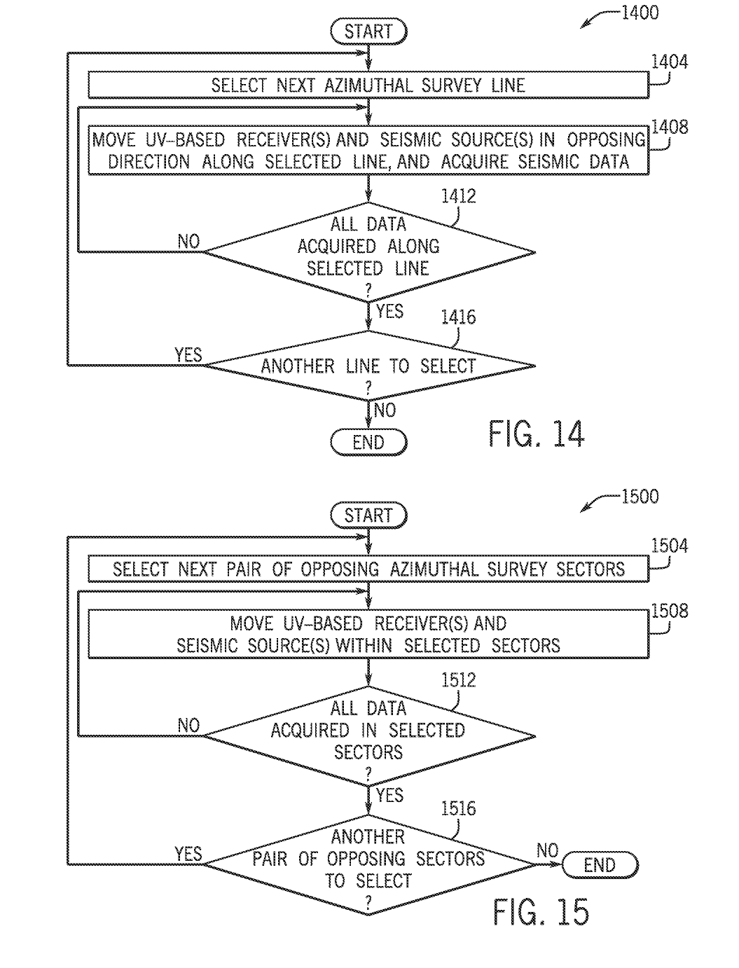

As a more specific example, FIG. 14 depicts a technique 1400 that may be used using the azimuthal line-based approach of FIG. 13A. Referring to FIG. 14, the technique 1400 includes selecting (block 1404) the next azimuthal survey line and moving the UV-based receiver(s) and seismic source(s) along the selected line, and acquiring seismic data, pursuant to block 1408. If a determination is made (decision block 1412) that all data has not been acquired along the selected line, then control returns to block 1408. Otherwise, a determination is made (decision made 1416) whether another azimuthal line needs to be selected; and if so, control returns to block 1404.

FIG. 15 depicts a techniques 1500 that may be used for the 3-D survey illustrated in FIG. 13B. Referring to FIG. 15, the technique 1500 includes selecting (block 1504) the next azimuthal survey sector and moving (block 1504) the UV-based receiver(s) and seismic source(s) within the selected sector, pursuant to block 1508. If a determination is made (decision block 1512) that all data has not been acquired in the selected sector, then control returns to block 1508. Otherwise, a determination is made (decision made 1516) whether another sector remains to be selected; and if so, control returns to block 1504.

In accordance with further implementations, the VSP survey may use a sufficiently long duration and/or sufficiently strong seismic source to ensure that the seismic reflections are recorded not only in a quiet down location but also near the surface in a potentially noisier location and after the wavefield has traveled farther.

In further example implementations, surveys may use a downhole seismic source in addition to or without a marine-based or surface disposed seismic source. Moreover, techniques may be used that apply passive seismic methods, where no active seismic source is used and only ambient noise is recorded, in accordance with yet further example implementations.

As other examples, the data may not be recorded concurrently by the downhole receivers and by the seismic UV-based receivers. For example, a portion of the shots may be fired while both the downhole receivers and the UV-based receivers are in place while more shots are fired without the downhole receivers in position.

In accordance with example implementations, the acquisition system may include a controller that coordinates the seismic source and receiver movements. In this manner, the controller may communicate with UVs to control source and receiver movements controlled by these UVs; and in accordance with some example implementations, the controller may communicate with platform equipment (as an example) to coordinate the movement of any downhole source(s) and/or receiver(s). The controller, in general, may be processor-based system. For example, the controller may be a physical machine that is formed from actual hardware and software, such as a machine that includes one or more processors (central processing units (CPUs), microcontrollers, field programmable gate arrays (FPGAs), and so forth) as well as a communication interface (a wireless transceiver interface to communicating control signals and data, for example) and non-transitory storage (a semiconductor device-based memory, for example) to store programs instructions, datasets, and so forth.

After acquisition, the data may be processed for various purposes, including near well imaging; integration and calibration of surface seismic data; amplitude versus offset (AVO) processing; depth model refinement processing; monitoring subsurface changes over time (time-lapse, or “4-D” monitoring) and so forth. During processing, the data may be combined with yet other seismic data sets, for instance, towed streamer survey data. Thus, many variations are contemplated, which are within the scope of the appended claims.

Other implementations are contemplated, which are within the scope of the appended claims. For example, in further implementations, the receivers that are disclosed herein may be, in general, any type of geophysical receiver, i.e., a receiver to acquire data that represents a survey of one or more geologic structures. In this manner, the receiver may be a seismic receiver, such as a particle motion sensor or hydrophone; a gravity sensor; an electromagnetic sensor, a magneto-telluric sensor; and so forth. Moreover, in accordance with example implementations, the techniques and systems that are disclosed herein may be used with surveys using active seismic sources (sources including air guns, or vibroseis sources, as examples), as well as surveys that use passive sources. For example, in accordance with example implementations, the systems and techniques that are disclosed herein may be used in a microseismic data survey in which receivers acquire data representing measurements made in response to hydraulic fracturing. In further example implementations, an acquisition system may use UVs to acquire data for a VSP survey, other than the specific ones described herein. Other types of VSP surveys include vertical incident, salt proximity, cross-well three-dimensional (3-D) and time-lapse, or “4-D,” VSP surveys.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
providing a plurality of acquisition components for performing a survey of a geologic region of interest, the plurality of acquisition components comprising receivers and at least one source;
using at least one marine unmanned vehicle to position at least one of the receivers in the survey; and
deploying at least at one of the acquisition components in a well or on land.

2. The method of claim 1, wherein the at least one source comprises a land-based source or a marine-based source.

3. The method of claim 1, further comprising conducting operations as part of a survey of the geologic region of interest in a transition zone, the transition zone comprising at least a first region submerged below water and a second region extending above water.

4. The method of claim 3, wherein the at least one source is one source of a plurality of land-based sources disposed on the second region, the method further comprising:
activating the plurality of land-based sources;
using a plurality of receivers disposed on the second region to acquire data representing energy attributable at least in part to the activation of the plurality of land-based sources; and
using the at least one receiver positioned by the at least one unmanned marine vehicle to acquire data representing energy attributable at least in part to the activation of the plurality of land-based sources.

5. The method of claim 3, further comprising:
activating at least one marine-based source in the first region;
using a plurality of receivers disposed on the second region to acquire data representing energy attributable at least in part to the activation of the at least one marine-based source; and
using the at least one receiver positioned by the at least one unmanned marine vehicle to acquire data representing energy attributable at least in part to the activation of the plurality of land-based sources.

6. The method of claim 3, wherein the at least one source comprises one source of a plurality of land-based sources disposed on the second region, the method further comprising:
activating the plurality of land-based sources; and
using the at least one receiver positioned by the at least one unmanned marine vehicle to acquire data representing energy attributable at least in part to the activation of the plurality of land-based sources.

7. The method of claim 3, wherein the first region comprises a relatively shallow water region and a relatively deeper water region, the method further comprising:
using at least one unmanned vehicle in the shallow water region to transport the at least one receiver;
using a surface vessel in the relatively deeper water region, wherein the surface vessel has a draft that is incompatible with a minimum depth of the shallow region; and
using the surface vessel to the at least one source.

8. The method of claim 1, wherein the receivers comprise receivers selected from the set consisting essentially of seismic sensors, gravity sensors, electromagnetic sensors and magneto telluric sensors.

9. A system comprising:
at least one source disposed on land;
at least one sensor;
at least one marine unmanned vehicle connected to the at least one geophysical sensor to acquire data representing energy attributable at least in part to the activation of the at least one source disposed on land.

10. The system of claim 9, wherein the unmanned vehicle comprises a remotely operable vehicle (ROV) or an autonomous vehicle (AUV).

11. The system of claim 9, further comprising:
a streamer adapted to be towed by the at least one unmanned vehicle, at least one sensor of the at least one sensor being disposed on the streamer.

12. The system of claim 9, wherein the at least one unmanned vehicle is adapted to remain within a first marine region to acquire the data in a survey of a geologic structure and the first marine region being associated with a minimum depth, the system further comprising:
a surface vessel having a draft incompatible with the minimum depth of the first marine region, wherein the vessel is adapted to transport a source fired in a second marine region associated with a deeper minimum depth compatible with the draft of the surface vessel.

13. The system of claim 9, further comprising:
at least one additional sensor disposed on land to acquire data representing energy attributable at least in part to the at least one source disposed on land.

14. A method comprising:
acquiring first data by at least one geophysical receiver inside a well, the first data representing energy attributable at least in part to at least one source; and
acquiring second data by at least one marine unmanned vehicle-based receiver outside of the well, the second data representing energy attributable at least in part to the activation of the at least one source.

15. The method of claim 14, wherein the at least one source comprises at least one active source or at least one passive source.

16. The method of claim 14, wherein the at last one source comprises at least one active source, the method further comprising:
moving the at least one active source; and
moving the at least one unmanned vehicle-based receiver in a coordinated manner with respect to the movement of the at least one active source.

17. The method of claim 16, further comprising performing a vertical incident vertical profile (VSP) survey or a walkaway VSP survey using the moving of the at least one active source and the moving of the at least one unmanned vehicle-based receiver.

18. The method of claim 17, wherein the at least one source comprises a plurality of active sources, and the at least one unmanned vehicle-based receiver comprises a plurality of unmanned vehicle-based receivers, the method further comprising:
performing a two-dimensional survey generally along a line; and
moving the plurality of active sources and the plurality of unmanned vehicle-based receivers along the line.

19. The method of claim 18, wherein moving the plurality of active sources and the plurality of unmanned vehicle-based receivers along the line comprises moving the plurality of active sources in a first direction along the line and moving the unmanned vehicle-based receivers in a second direction along the line, the second direction being opposed to the first direction.

20. The method of claim 17, wherein the at least one source comprises a plurality of active sources, and the at least one unmanned vehicle-based receiver comprises a plurality of unmanned vehicle-based receivers, the method further comprising:
performing a three-dimensional survey along different azimuthal directions; and
moving the plurality of active sources and the plurality of unmanned vehicle-based receivers along the azimuthal directions.

21. The method of claim 20, wherein moving the plurality of sources and the plurality of unmanned vehicle-based receivers in the azimuthal directions comprises:
designating a plurality of azimuthal lines;
selecting a pair of opposing azimuthal lines from the plurality of azimuthal lines, moving the plurality of sources along one of the selected azimuthal lines of the pair and moving the plurality of unmanned vehicle-based receivers along the other selected azimuthal line of the pair; and
selecting another pair of opposing azimuthal lines from the plurality of azimuthal lines and repeating the moving of the sources and receivers.

22. The method of claim 20, wherein moving the plurality of sources and the plurality of unmanned vehicle-based receivers in the azimuthal directions comprises:
designating a plurality of azimuthal sectors;
selecting an opposing pair of azimuthal sectors from the plurality of azimuthal sectors, moving the plurality of sources along one of the sectors of the selected pair and moving the plurality of unmanned vehicle-based receivers along the other sector of the selected pair; and
selecting another opposing pair of azimuthal sectors from the plurality of azimuthal sectors and repeating the moving of the sources and receivers.

23. The method of claim 14, further comprising:
moving the at least one receiver inside the well; and
moving the at least one of the unmanned vehicle-based receiver in a coordinated manner with respect to the movement of the at least one receiver inside the well.

24. A system comprising:
at least one seismic source;
at least one receiver disposed in a well, the at least one receiver adapted to acquire first data representing energy attributable at least in part to the activation of the at least one seismic source; and
at least one unmanned marine vehicle-based receiver outside of the well to acquire second data representing energy attributable at least in part to the activation of the at least one seismic source.

25. A method comprising:
activating at least one seismic source, the at least one seismic source being disposed in a well; and
acquiring data outside of the well by at least one unmanned marine vehicle-based receiver, the data acquired by the at least one unmanned marine vehicle-based receiver being attributable at least in part to the activation of the at least one seismic source.
